(19) United States
(12) Patent Application Publication
(10) Pub. No.: US 2017/0162053 A1
(43) Pub. Date: Jun. 8, 2017

(54) ROAD SAFETY WARNING SYSTEM

(71) Applicant: TDG Company LLC, Newport Beach, CA (US)

(72) Inventors: Pere Margalef Valldeperez, Newport Beach, CA (US); Lukasz J Sliwka, Long Beach, CA (US)

(21) Appl. No.: 15/433,123

(22) Filed: Feb. 15, 2017

Related U.S. Application Data
(63) Continuation-in-part of application No. PCT/US2015/039675, filed on Jul. 9, 2015.

(51) Int. Cl. G08G 1/16; G08G 1/052; G08G 1/127; G08G 1/0967

(52) U.S. Cl. CPC G08G 1/164; G08G 1/096775; G08G 1/052; G08G 1/127

(57) ABSTRACT

A method for providing traffic data by GPS based vehicle position data at a central data base from a plurality of vehicles including at least one car or truck and a least one bicycle via separate connections from the vehicles, tracking the speeds and positions of each vehicles and determining from the tracked speeds and positions when the one of the vehicles, such as a cycle, is approaching another vehicle and traveling in the same direction on the same roadway. The method includes determining when at least two of the vehicles enter a notification zone there between and notifying another vehicle, such as a car or truck, that the other vehicle or vehicles has entered the notification zone. Historical analysis of collected data may be used to aid current traffic data based on the detection of specific traffic events or patterns of events and may be used for

### RELATED APPLICATIONS

This application claims the priority of the filing date of U.S. Provisional Application Ser. No. 62/037,686 filed Aug. 15, 2015, which is incorporated by reference herein in its entirety.

This application claims the priority date of PCT Patent Application Serial Number PCT/US2015/039675, filed Jul. 9, 2015, which is incorporated by reference herein in its entirety.

### BACKGROUND OF THE INVENTION

Field of the Invention

This invention is related to tracking vehicles on roadways to collect information about the relative position, speed and/or acceleration of the vehicle over time. In particular, the invention is related to collecting and analyzing information about vehicles being tracked in order to provide useful information to one or more vehicle operators in real time about conditions of the roadway, such as traffic or other data about other vehicles on the same road.

Description of the Prior Art

Motorcycle accidents, including accidents involving other vehicles such as cars and trucks, are a sobering fact that should be considered by anyone who rides a motorcycle, whether for work transportation or simply pleasure. Over 4,000 people die in motorcycle accidents each year. In 2008, a record of 5,209 fatalities occurred due to motorcycle accidents.

According to national statistics, fatalities in motorcycle accidents per year have been steadily increasing since the late 1900's. In fact, there has not been a decrease in fatalities from 1997 through 2008 for even one year. In 2004, there were over 5.7 million registered motorcycles. For that number, there were 4,008 fatalities. In other words, for every 100,000 registered motorcycles, there were 69.33 fatalities that year. While motorcycles were only 2% of all registered vehicles, they were involved in over 5% of highway fatalities alone and 14% of all traffic accidents.

While motorcycle registrations are increasing, the increasing fatalities were not due to the increase in numbers. The National Highway Traffic Safety Administration (NHTSA) analyzes accidents in many ways, one of which includes noting the number of fatalities per 100 million miles traveled. This allows the actual rate of fatalities to be compared separate of the increasing number of bikes. The rate of fatalities per 100 million miles traveled has increased drastically from the late 1900's into the 2000's. The increase between 1997 and 2004 was 89%.

Although consciousness and awareness from the driving community is rising, motorcycle accidents, and particularly motorcycle accidents involving automobiles, have been very hard to prevent. One of the main reason behind this statement is that 4-wheeled vehicle drivers cannot see motorcycle drivers approaching them until it is too late to correct a maneuver that may put in risk the motorcycle rider.

What is needed are techniques for helping the 4-wheeled vehicle driver to be aware of the presence of motorcycle nearby before establishing visual or acoustic contact, her/his awareness would increase and would persuade any abrupt or sudden maneuver that may provoke an accident with the approaching motorcycle. There is also a need to improve navigation and traffic applications for all vehicles.

### SUMMARY OF THE DISCLOSURE

A method for providing traffic data is disclosed including receiving satellite based vehicle position data at a central computing service including a database from a plurality of vehicles including at least one car or truck and a least one motorcycle or bicycle. The signals are received via separate connections from the vehicles. The speeds and positions of each of the vehicles are tracked continuously and may be maintained for historical purposes. The technique includes determining from the tracked speeds and positions when a motorcycle is approaching a car or truck and traveling in the same direction on the same roadway. The technique may also or alternately include determining from the tracked speeds and positions, for example by predictive analysis, when a car or truck is approaching a bicycle traveling in the same direction on the same roadway. Such predictive analysis may use algorithms based on speed, position and/or historical analyses of prior collected vehicle traffic data.

Upon determining when the car or truck and motorcycle or bicycle enters a notification zone there between, one or both of the vehicles may be notified that the other has entered the notification zone. Satellite based vehicle position information is received in each of the vehicles and satellite based vehicle position data based the position information for each of the plurality vehicles may be transmitted via cellular signals from the vehicles to the database. The data received at the database includes vehicle type data to distinguish cycles, such as bicycles, motorcycles and the like from other vehicles such as cars and trucks.

The signals received from satellites may be processed in a computing system, such as a smartphone, on or in each of the vehicles to determine position information for each vehicle and vehicle type data may be transmitted from cycles with the vehicle position data. The vehicle type data for motorcycles and/or bicycles may be computed from accelerator signals measured on the cycle, e.g., from accelerators built into some smartphones.

Satellite based position data received at the central data base may be used to create maps for navigation systems using routes and traffic patterns more suitable for two wheeled vehicles than for vehicles having four or more wheels and/or to analyze traffic conditions.

The notifications may indicate the relative distance in space or time between the cycle and other vehicle while the vehicles are within the notification zone.

### BRIEF DESCRIPTION OF THE DRAWINGS

FIG. 1 is a high level block diagram of approaching vehicle tracking system

FIG. 2 is a process flow diagram of approaching vehicle warning application (i.e., smartphone app or other software) 28.

FIG. 3 is a graphical representation of interactive area (IA) 46.

FIG. 4 is a schematic representation of analyze relative position, step 42, shown in FIG. 2 above.

FIG. 5 is a graphical representation of approaching vehicle warning application 10 in accordance with another embodiment.

FIG. 6 is a graphical representation of an arc generation of the approaching vehicle warning application.

FIG. 7 is a table of probabilities of changing direction by a vehicle.

FIGS. 8 and 9 are graphical representations of an arc generation for a vehicle.

FIGS. 10, 11, and 12 are graphical representations of arcs for generating geospatial polygon shapes.

FIG. 13 is a process flow diagram of approaching vehicle warning application 10 in accordance with another embodiment.

### DETAILED DISCLOSURE OF THE PREFERRED EMBODIMENT(S)

In a first embodiment, a safety technique for 2-wheeled vehicles (e.g., motorcycles, bicycles, etc.) is disclosed which may be used to alert drivers of 4-wheeled vehicles (e.g., cars, trucks, buses, etc.) of the presence of approaching 2-wheeled vehicles in order to increase their alertness and avoid abrupt maneuvers that may result harmful for the motorcycle or the bicycle drivers. The number of wheels per vehicle is not critical but the concept of a car 12 tracking an approaching motorcycle 14 is one of the preferred embodiments.

In general, motorcycle riders want drivers of cars they are approaching to be aware of the approaching motorcycles because motorcycles are far less noticeable in the car's rear view mirrors. Many motorcycle accidents and fatalities are believed to be caused by car drivers making quick or unusual maneuvers, even just opening the driver's door, unaware of an approaching cycle. The distance between the motorcycle and car when the motorcycle rider wants the car to be aware of the approaching motorcycle depends on many factors including speed, type of road, and perhaps road conditions.

The term “potential interaction zone” is used herein to generally describe an area around the car or other vehicle which, when entered by the other vehicle such as a motorcycle or the like, when a notification to the car provides a benefit to the motorcycle and car driver. The term “potential interaction zone” therefor may include an area much larger than the area between the vehicles when they can physically interact and must also include the area in which the car driver may notice the motorcycle and have time to process the fact that unexpected and/or quick maneuvers are substantially more risky than if a car was approaching.

Transmitters and/or receivers may be associated with one or more vehicles such as bicycles, 2 and 3 wheeled motorcycles, cars, trucks and other vehicles, for example by downloading an app into a smart phone carried by the vehicle or the vehicle operator. Other systems including dedicated hardware or other software may be used.

In a preferred embodiment, each smart phone when equipped with the app and operable may transmit a vehicle position signal, for example, by text message or other cell phone transmission. The vehicle position signal may conveniently be a regularly transmitted GPS derived location signal, for example derived from a GPS receiver in the smart phone in which the app is loaded. The position signal transmitted from a first vehicle, such as a properly equipped tracking car or other tracking vehicle 12, may then be stored in a central computing system database.

Similarly, the transmitted vehicle position signal from a second vehicle, for example, a tracked motorcycle or other tracked vehicle 14, may also be stored in the central database. Software associated with the app may be used to determine when two or more vehicles using the app are located within a selected range of each other. When the vehicles are determined to be within the selected range of each other, at least the tracking car may then receive a notification via the smart phone in which the app is loaded, indicating that the tracked vehicle is within the determined range. In some embodiments, the tracked vehicle may also receive a similar signal.

The dimensions of the selected range may be controlled by the app, the cell phone user and/or conveniently by the software associated with the app and the central database.

For example, when tracking vehicle 12 is a car, and tracked vehicle 14 is a cycle such as a motorcycle, then when the motorcycle approaches the car, the car may receive a signal that the motorcycle is approaching, as a safety warning to pay attention to the cycle. Transmitters may communicate with the receivers directly or by other networks, and when they are determined to be within a notification range, such as selected interactive area 46 (IA 46), the communication between the systems allows each receiver to determine:
Presence of one or more properly equipped tracked vehicles 14, such as a motorcycle, within a certain a range of a properly equipped tracking vehicle 12 such as a car.
Relative location of the motorcycle(s) to the car.
Speed and/or acceleration (or relative speed or acceleration) of the motorcycle(s).
Elapsed time for the motorcycle(s) to overtake the car.

In one embodiment, the signal from the transmitter may activate a visual alarm (i.e., LED light) or an acoustic alarm near the 4-wheeled driver through the receiver. This alarm would turn off once the transmitter (e.g., motorcycle) is outside the established range to increase the awareness of the 4-wheeled drivers in the event of being motorcycles or bicycles around. Alternately, the notification may include notification of the rate of speed, acceleration and/or time or distance until the tracked vehicle overtakes the tracking vehicle. By increasing the awareness of the drivers, it may decrease the number of motorcycle and bicycle accidents on the roads.

Various transmission technologies that can be used for direct vehicle to vehicle communication including radio frequency, Bluetooth, Bluetooth Low Energy (BLE), Radio Distance Magnetic Indicator (RDMI), cell phone signal communications and/or radar, together with IP communications via networks including the Internet. Position information, for example, may be derived directly from RF signals from GPS satellites and/or via cell towers and/or IP networks.

In the presently preferred embodiment, the transmitters are realized via a mobile application, or app, typically on smartphone devices. In this case, tracked vehicle 14 and tracking vehicle 12 would have the mobile application installed in smartphone devices (for example, related to the driver and/or vehicle) which would establish communication in the event of tracked vehicle 14 approaching tracking vehicle 12. The smartphone, or other device in which the software or app is loaded, would then alert the tracking vehicle 12 driver and would provide the relative location, speed and time in which it will be reached or passed by tracked vehicle 14. The warning could appear in a smartphone, a dedicated navigation system or integrated into a system such as Waze, Apple Maps or Google Maps.

In another embodiment, only tracked vehicle 14 driver may have the smartphone mobile application while tracking vehicle 12 may have a dedicated receiver with a display showing the information about tracked vehicle 14 (speed, relative location, time before tracked vehicle 15 reaches tracking vehicle 12, etc.). Both systems could communicate via one or more of the technologies named above and the like. A GPS navigation system from the smart mobile device, or other navigation system, could connect with all the receivers and would provide the relevant information.

Importantly, the mobile application could be used to allow motorcycle riders to determine how many 4-wheeled drivers are equipped with the described system which may help them to determine which routes are more and less safe before starting the motorcycle ride. For example, a conventional vehicle navigation system may be modified to display by color, line thickness or other mechanisms the number of motorcycles and/or the percentage of vehicles which are motorcycles for each of various possible routes or other trip planning purposes.

Similarly, navigation systems may be modified to present proposed or alternate routing for motorcycles based on difference in behavior of motorcycles in traffic. A simple example might be that side roads, smaller lanes and winding roads may have a somewhat higher priority for a motorcycle than another vehicle such as a car. Further, motorcycle riders may well prefer roads which over time have a higher percentage of use by motorcycles. For example, in the Los Angeles area, a portion of Mulholland drive is considered a desirable place to ride a motorcycle for various reasons.

Similarly, in the foothills, there are winding mountain roads that are very enjoyable on a motorcycle but may not be as desirable for cars. When planning routes, or rerouting for traffic conditions, such winding mountain roads may have a higher priority as a primary or alternate route for motorcycles than for cars.

Alternately, one or both of the vehicles may include all the necessary equipment as a safety device, for example, provided as part of the standard equipment of all car and/or motorcycle manufacturers.

Many alterations and modifications may be made by those having ordinary skill in the art without departing from the spirit and scope of the invention. Therefore, it must be understood that the illustrated embodiment has been set forth only for the purposes of example and that it should not be taken as limiting the invention and claims as defined by the following disclosure and its various embodiments.

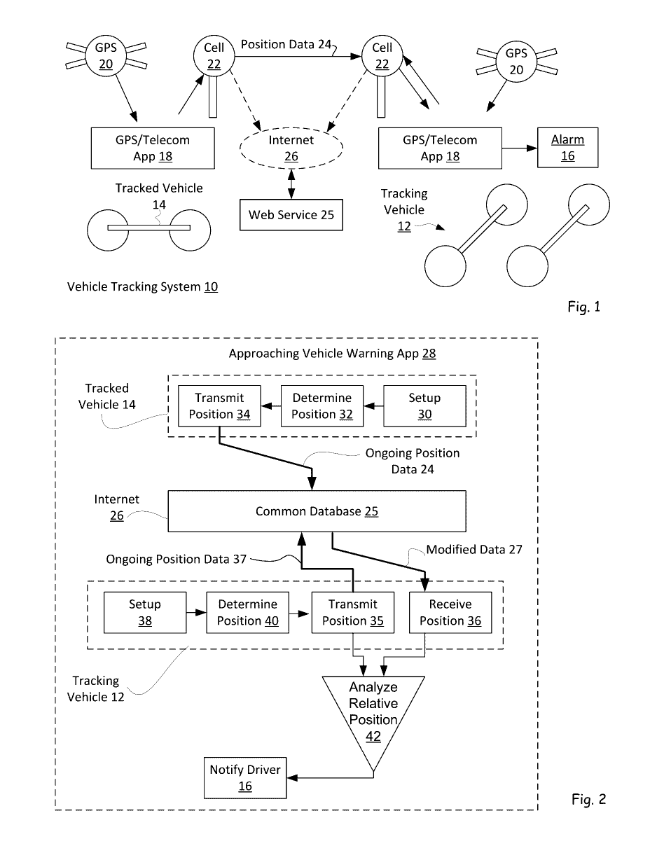

Referring now to FIG. 1, vehicle tracking system 10 notifies tracking vehicle 12 of the approach of tracked vehicle 14. In one embodiment vehicle 12 may be a car or truck or other vehicle while vehicle 14 may be a motorcycle, tricycle, bicycle or other similar cycle or vehicle. In this embodiment, when motorcycle 14 is approaching car 12 at a speed at which motorcycle 14 will likely overtake car 12 within a fixed period or distance, e.g., 20 seconds, alarm 16 may be used to make the operator of tracking vehicle 12 aware of the likely approach of motorcycle 14 so that the operator of vehicle 12 can avoid vehicle operation that might cause an accident between the vehicles. The operators of vehicle 12 or 14 may be human or computer assisted vehicle operator such as may be found in a driverless car.

For example, as driverless cars become more widely used, in one embodiment, such tracking vehicles 12 may use approaching vehicle tracking system 10 to warn the driverless vehicle of the approach of a tracked vehicle 12 for causing tracking vehicle 12 to operate in a more conservative manner. Similarly, when either vehicle tracking system 10, and/or driverless vehicles, become widely used, in addition to tracking vehicles approaching from behind along a single roadway, the same techniques may be used to track all vehicles by requiring the use of transmitted position signals from many if not all vehicles so that vehicles approaching intersections may at least in some situations be warned of the positions of other vehicles being tracked.

In operation of system 10, shown in FIG. 1, GPS/Telecom App 18, may be a hardware/software device which obtains continuous position data, such as GPS data from satellites 20, which data is provided sufficiently continuously for tracking vehicle 12 to use the position data as required by the implementation of tracking system 10.

App 18, associated with tracking vehicle 14, e.g., on the vehicle or the driver, may then transmit the ongoing position data of tracked vehicle 14 for use by tracking vehicle 12, for example by cell phone tower 22 or a similar data system including at least transmitted data. Bi-direction transmission may be used to make tracked vehicle 14 aware of one or more tracking vehicles 12, e.g., ahead in the direction of travel of vehicle 12. After the position data is received by cell tower 22, it may be transmitted as ongoing position data 24 through one or more cell towers 22 and/or re-transmitted via Internet 26 and/or other transmission techniques including Wi-Fi.

Ongoing tracked vehicle position data 24 may then be made available to tracking vehicle 12, for example by the same or a different GPS/Telecom App 18 associated with tracking vehicle 12. After suitable analysis, as discussed below with regard to other figures, alarm 16 may be utilized to provide suitable information to the operator of vehicle 12 indicating, for example, that a motorcycle is approaching from behind or from any other direction.

GPS/Telecom App 18 may include a combination of hardware and/or software components, but in a preferred embodiment with substantial additional advantages, GPS/Telecom App 18 may be implemented as an app installed in a smart phone, smart watch, tablet or any in-dash car multimedia system.

Referring now to FIG. 2, an overview of approaching vehicle warning app 28 installed in a smart phone or similar device (not shown in this figure) and/or in part on common database 25 on internet 26, is described which may advantageously provide an implementation of GPS/Telecom App 18 in vehicles 12 and 14 including additional components such as alarm 16. In alternate embodiments, the tracking and tracked vehicles apps may be different. Preferably, ongoing position data 24 for tracked vehicle 14 may be provided via telecom or similar services to common database 25 on internet 26 and thereafter provided as the same or modified data 27 to tracking vehicle 12.

In operation, setup step 30 in the tracked vehicle 14 portion of combination app 28 may be operable by the operator of vehicle 14 to input vehicle data (such as motorcycle, bicycle or other vehicle type), and/or additional data, to be used in ongoing position data 24 transmitted to tracking vehicle 12. Many smartphones, tablets and similar computing systems includes accelerometers which may be used to determine vehicle type at least for motorcycles. For example, motorcycles typically lean into turns which can be detected by such accelerometers and used to distinguish cycles from other vehicles and thereby create and/or confirm cycle type data.

During determine position step 32, the current position, speed and/or acceleration of vehicle 14 may be determined by, for example, the use of a GPS receiver such as those now relatively standard in smart phones. The determined position data, which may be conditioned by the contents of setup step 30, may be used in position transmission step 34 to provide ongoing position data 24 to tracking vehicle 24 via cell data and/or internet data and/or other convenient data transmission mechanisms and/or a combination of thereof.

In particular, ongoing position data 24 may be applied to and/or stored in database 25. However, when retrieved therefrom for tracking vehicle 14, the position data may be modified to provide modified data 27. For example, especially when position related vehicle app 28 is used widely, the position data received from tracked vehicle 14 may be modified, analyzed and/or compared to map position data such as highway and/or traffic data and/or compared to the same or similar data related to tracking vehicle 12. For example, modified data 27 may include relative position data based on both tracked vehicle position data 34 and tracking vehicle position data 37 (discussed below in greater detail) to fully or partially determine the relative position between the vehicles, the time or distance before co-location, and/or other relevant information about one or more of the vehicles and/or data related to the roadway, current weather and/or traffic conditions and the like.

Alternately, the data applied to tracking vehicle 12 may only contain data related to the position of tracked vehicle 14 or some combination of such position and other data. Depending upon the position data content and/or transmission mechanism, receive position step 36 in the tracking vehicle 12 portion of app 28 may receive ongoing position data 24 (and/or modified data 27) from database related to vehicle 14. Upon proper data entry in setup step 38, self-position determination in step 40, e.g., GPS data, transmit position step 35 may be provided as ongoing position data 37 to common database 25 and/or analyze relative position step 42. Step 42 may be performed in whole or in part in association with common database 25 via internet 26 or other wide area network and/or locally at vehicle 12. In either event, the relative positions, speed and acceleration of the vehicles may be analyzed in step 42 if not partially or fully analyzed before transmission to tracking vehicle 12, e.g., in database 25. When appropriate, the operator of tracking vehicle 14, and/or tracked vehicle 12, may be made aware of the approach of vehicle 14 to the position of vehicle 12 via notify driver alarm step 16 in order to improve safety for both vehicles. Drive alarm 16 may indicate relative distance in space or time between the tracked and tracking vehicles while they are within the notification zone.

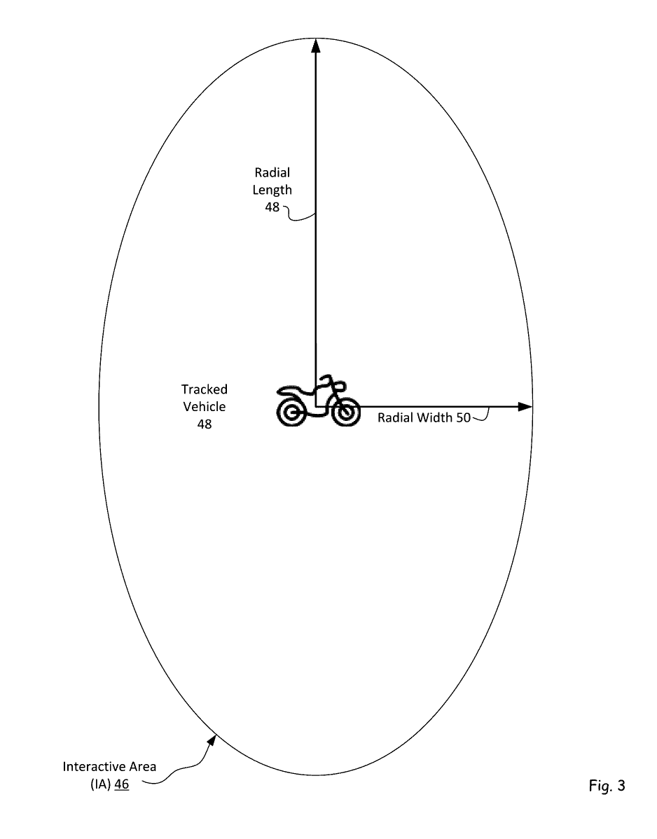

Referring to FIG. 3, in a preferred embodiment, the operation of steps 40, 36 and 42 related to tracked vehicle 14 may conceptually include the use of interactive area (IA) 46. Interactive area 46 may be a circular, elliptical or other shaped area which may have a radial length 48 generally parallel to the roadway on which tracked vehicle 14 is traveling and/or a radial length 50 related to the width of that roadway. IA 46 may be used for determining which vehicles are being tracked within the fixed or variable area defined by radial lengths 48 and 50 and it may keep its physical center at the exact location of tracked vehicle 14, and update as the vehicles move.

In other words, each tracked vehicle 14 may have its own IA 46 and this may travel with the vehicle. IA 46 is an easily recognized representation of the potential interact or notification zone when a notification to one or more of the vehicle drivers for safety and convenience is appropriate. The size of the interaction zone may be based on a distance scale, e.g., the number of feet, meters or car lengths between the vehicles and/or on a time scale, e.g., the remaining time before the motorcycle overtakes the car, or a combination of such factors. In any event, the potential interaction zone represents the zone when entered which requires notification to one or more vehicles and may also be called the notification zone.

Radial lengths 48 and 50, for IA 46 related to vehicle 14, may be fixed or may be dependent on speed and acceleration of tracked vehicle 14 in order to modify and/or control the operation of driver notification 16, for example the time to notify the driver of tracking vehicle 12 before vehicle 12 is overtaken by approaching tracked vehicle 14. For the same reason, radial width 48 and length 50 may also be varied in accordance with the type of tracked vehicle 14 being monitored. For example, slower vehicles such as bicycles may need to have shorter radial width and length than faster vehicles such as motorcycles.

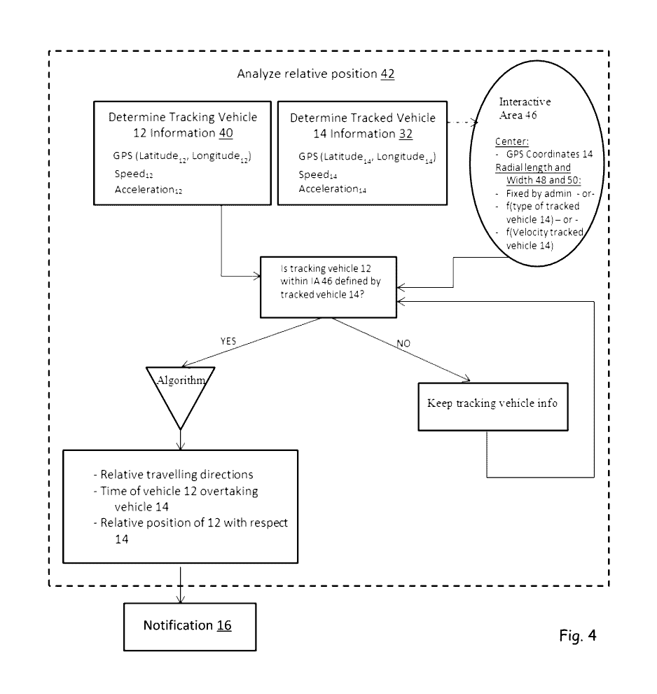

Referring now also to FIG. 4, to analyze the relative position step 42, travel information of tracking and tracked vehicle 12 and 14, GPS coordinates, velocity and acceleration may be constantly monitored and stored in database or similar storage media. Each tracked vehicle 14 may define a separate IA 46 which, as shown in FIG. 3, may be circular or elliptical and its center may be defined by the ongoing GPS coordinates of tracked vehicle 12 or tracking vehicle 14. Radial length 48 and width 50 may be: (1) fixed by the system administrator; (2) may vary depending on the type of vehicle; or (3) may be a function of the velocity of the tracked and/or tracking vehicle. In a preferred embodiment, app 28 may compare the GPS coordinates between vehicles, and if the location of any tracking vehicle 12 falls enters area IA 46 for tracked vehicle 14, or alternately, tracked vehicle 14 enters IA 46 of tracking vehicle 12, the system may send alarm notification 16 to tracking vehicle 12 to notify of existing tracked vehicle 14 in the surroundings in order to improve safety of both vehicles.

Vehicles within IA 46 may be in communication with each other constantly during the time that both vehicles are within IA 46 and alarm 16 may be sent only once in order to not overwhelm the driver of tracking vehicle 12 with continuous notifications. In the event of tracking vehicle 12 exiting the IA 46 defined by the tracked vehicle 14, the herein defined processes in FIGS. 1 and 2 and 4 will start again to establish the same type of communication between the two exact same vehicles in the event of the tracking vehicle re-entering the IA 46 defined by the tracked vehicle 12.

In addition to the relative speed between vehicles 12 and 14, the directions of travel of these vehicles may be determined in order to calculate the time for vehicle 14 to overtake vehicle 12 as well as to provide more detailed information about tracked vehicle 14 to tracking vehicle 12. Notification 16 may include data such as speed, relative speed and/or time before on vehicle overtakes the other so that one or both drivers can monitor the approach of the other vehicle.

As noted above, analyze position step 42 may be performed in one or both of the vehicles and/or in association with common database 25. Alternately, the changing position data of one of or both vehicles can be analyzed in whole or in part in one or both vehicles, common database 25 and/or transmitted there between. Advantageously, when at least some of the ongoing position data for either or both vehicles is available via the internet, this data may be mined for information related to traffic flow patterns, traffic incidents and/or related instantaneous traffic condition information.

At least one conventional traffic monitoring system, Waze, recently by Google, provides apps for enhancing GPS roadway navigation with estimated traffic patterns based on GPS location data gleaned from users of the app in what has been called a community based traffic and navigation system. Data from analysis of tracked and tracking vehicles can be used to enhance such community based traffic systems directly and also using additional information not conventionally used by—or even available for use by such community based or other traffic systems.

In heavily traveled freeways, motorcycles often have an advantage during traffic incidents in that they can more easily switch lanes. The data available via apps 18 and/or 28 may be analyzed to both distinguish which vehicles may be motorcycles and to detect and/or identify certain types of traffic conditions based on the differences between the way motorcycles act differently than 4 wheeled or larger vehicles.

As a simple example, when traffic is stop and go on a stalled freeway, motorcycles often thread their way between lanes of traffic and thereby, although slowing down, maintain a higher average speed than cars as they slow down. By monitoring rates of change of speed between cars and motorcycles, the timing and severity and/or type of a traffic incident may be almost instantaneously be determined. The relative rate of change of speed of different types of vehicles during the formation, duration and eventually break up of a traffic jam may more accurately provide a picture of the traffic jam so that alternate routes may be taken.

Simply said, when traffic jams begin forming, cars and motorcycles slow down, but the motorcycles may slow done less. When a traffic jam has formed sufficiently so that cars are not able to change lanes to move, motorcycles can often still make substantial, distinguishable progress, e.g., by driving between lanes. When traffic jams breakup, motorcycles are often able to move more rapidly into the lanes where traffic begins to move. The ability to compare the relative changes in speed and position between vehicles may substantially enhance the accuracy of traffic information available to navigation system users.

Referring now again to FIGS. 1 and 2, vehicle tracking system 10 may continuously collect and track GPS coordinate data for vehicles in real time and distinguish between vehicle types, such as motorcycles and cars, trucks and buses based on setup and/or behavior data such as two wheel vehicles leaning during lane changes. Such ongoing tracking for identifiable vehicles permits computing equipment in web service 25 including database 25 to determine the speed and direction of each vehicle as well as tracking that vehicle along known roadways. This information may then be used to determine if and when such vehicles may intersect in space and time in order to timely provide notification, for example, of a two wheeled vehicle approaching a car.

Further, the collection and storage of such real time data especially when vehicle type identification is detected and/or otherwise obtained, allows the navigation system to produce information not otherwise obtainable. Such new information may be related to and useful for traffic management based on an analysis of differences in speeds and/or changes in speed between vehicle types in order to clarify the growth and decay of traffic incidents such as traffic slowdowns and jams.

It is important to note that current GPS signals available for non-military purposes have limited ability to distinguish spatial differences on the order of the width of a typical highway lane. That is, it is currently difficult and likely impossible, using only GPS signals, to determine which lane of a multilane highway a vehicle is in or whether a particular vehicle transmitting GPS position data has changed lanes. The data being collected by vehicle tracking system 10, using vehicle tracking data including vehicle type, can distinguish some information not otherwise available such as that although most vehicles are slowing down to a very slow speed, motorcycles are able to continue to make more progress that cars and trucks. In addition to the narrow width of cycles, such as bicycles and motorcycles, cycles are not often driven between lanes when there's a large difference in speed for example on a highway.

As a result, data from a few identified cycles in a dense traffic pattern may be a useful indication of actual condition on the roadway. When a slowdown starts, some cars and motorcycles will change lanes. After such early lane changes are completed for the cars, cycles may continue lanes changes for a while. Thereafter, cars and trucks are likely to stay in their own lanes while slowing down. Thereafter, when cars are slowed down to what is often called stop and go traffic, motorcycles and other cycles may continue to switch lanes and/or ride between lanes and thereby continue to make more progress than the cars until traffic is completely or almost completely stopped.

Similarly, as the traffic slow down begins to break up, motorcycles are often able to weave through the slowly starting traffic to reach the head of the pack. Such changes can be determined in a remote database using vehicle data type collected by tracking system 10 including vehicle type data, at least for cycles, but may not currently be made via remote processing of GPS data. The only conventionally available practical mechanism for gathering such traffic condition data for high traffic roadways such as highways and freeways, beyond currently available data from analysis of GPS position information from navigation systems, appears to be analysis of traffic camera information. The cost and accuracy of traffic camera supplemented traffic data for navigation systems limits its use.

Similarly, the collected data from system 10 may be archived and/or can be used for predictive analysis purposes, e.g., t to teach crash avoidance systems in use in more and more vehicles to react to events and patterns of events based on collected historical data. For example, one of the most perplexing traffic problems to ameliorate are traffic slowdowns resulting from the fact that drivers almost always slow down more quickly than they accelerate on highways. This may be called wave action. Often, although the details may be not be completely understood, it seems that when one or more drivers unexpectedly slow down for some reason, other drivers may slow down more than necessary slowing down all traffic behind them.

Sometimes this wavelike effect can bring traffic to almost a standstill, yet traffic eventually—and more slowly—resumes normal speed and no other traffic events seem to have been the cause. Similarly, during traffic slowdowns including wave action, vehicles especially motorcycles and often cars can be seen to more likely quickly change lanes trying to avoid the slowdown which may begin just in one or more lanes. The quick shifting to other lanes then often results in an increasing traffic slowdowns Predictive analysis based on a historical database of vehicle speeds from system 10, advantageously including the benefit of increased information available from the ability to identify motorcycles from other traffic, may be used to better understand traffic flow problems and reduce negative effects of patterns like wave action. For example, the driving public could become aware of wave action issues and the vehicles could be equipped to notify the driver to stay in lane to reduce wave action.

Still further, similar problems result from other traffic events, or patterns of events, that may be analyzed, better understood and hopefully be reduced by analysis of historical data from system 10. Such data may be provided directly to vehicle collision avoidance systems for traffic management and collision avoidance. In the future, as traffic apps with vehicle type information become more commonly used and perhaps eventually made mandatory, differences in the traffic characteristics of various vehicle types, can be used to substantially improve traffic flow and reduce accidents.

One use of vehicle type data may be to identify which roadway lane a vehicle is in. Clearly, when the vehicle type is bicycle and the roadway includes a bicycle lane, the vehicle may be assumed to be in a vehicle lane. A more sophisticated use of the vehicle type data may be to include the use of car pool and/or other express lanes. This data type may be of particular use in analysis of historical data to predict current or future traffic patterns.

Further, traffic laws are evolving to provide more and more protection to bicyclists. In many areas bicycle lanes are used to separate traffic. However desirable for safety and energy savings, bicycles even in lanes may impede traffic by slowing it down. For example, in some streets in Long Beach, Calif. or increasing in other cities, the primary traffic lanes are used jointly by bicycles and other vehicles. Currently, bicycles may have priority which can make the roadway less desirable as a primary or alternate navigation path for other vehicles.

Still further, cycles often travel in groups of many motorcycles or many bicycles. Using both GPS position and speed data coupled with vehicle type information available from tracking system 10 allows identification of such groups which may be useful in tracking either motorcycle or bicycle tours as well as for traffic and alternate route data. Similarly, historic data may be acquired regarding bicycles as well as motorcycles, perhaps together with reported accidents, so that vehicles can be notified when entering specific roadway areas with unusually high (or low) cycle density and/or cycle accident histories.

Community based traffic and navigation apps, such as Waze, compete with each other to be most useful to drivers and even small improvements may make a major difference in acceptance by the public. A large community based traffic and navigation app which is particularly useful to a specific community, such as motorcycles and bicycles, provides added vehicle safety and more detailed traffic information which may reduce accidents and energy use, so every improvement may be important.

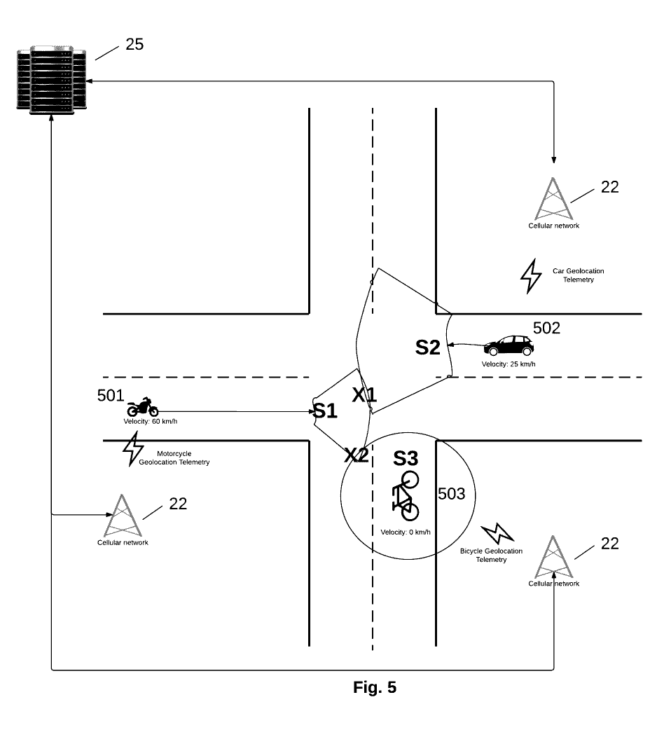

Referring now to FIG. 5, vehicle tracking system 10 executes approaching vehicle warning app 28 that includes generating geospatial polygon shapes for probable vehicle paths and interactions of these paths for each vehicle to determine the possibility of a collision and the time to collision. The embodiments described for FIGS. 5-10 may be used in the embodiments described for FIGS. 1-4 or may use all or parts of the embodiments described for FIGS. 1-4. Approaching vehicle warning app 28 executes a method of alerting a user of a mobile communication device about a risk arising from proximate drivers. In some embodiments, the method comprises gathering geolocation telemetry and sending it in real-time via cellular networks to vehicle tracking system 10 for calculating a geospatial polygon shape representing a forecast of approximate future position. A geospatial polygon shape calculation algorithm determines the right kind of polygon shape depending on several factors, such as like velocity, vehicle type, direction of travel, traffic conditions, road type and curvature, road features like intersections, GPS accuracy and network latency. Other factors may be taken into account by a machine learning algorithm trained to optimize the geospatial polygon shape to maximize the accuracy of the future position forecast of a vehicle. Intersections of the geospatial polygon shapes S1, S2 and S3 in the system indicate possible collisions resulting in alerts being sent by approaching vehicle warning app 28 to appropriate mobile communication devices of vehicles.

As shown in FIG. 5, a motorcycle 501 traveling at high speed and approaching an intersection is transmitting its geolocation telemetry via a mobile communication device. Vehicle tracking system 10 uses the telemetry to forecast a geospatial polygon S1 for motorcycle 501. At the same time, a car 502 is traveling in the opposite direction at much lower speed and approaching that intersection while transmitting its geolocation telemetry via a mobile communication device. Vehicle tracking system 10 uses the telemetry to forecast a geospatial polygon S1 for car 502. Finally, in this example, a bicycle 503 is stationary at the same intersection while transmitting its geolocation telemetry via a mobile communication device. Vehicle tracking system 10 uses the telemetry to forecast a geospatial polygon S3 for bicyclist 503. Vehicle tracking system 10 determines that geospatial polygons S1, S2, and S3 intersect at points X1 and X2; accordingly, vehicle tracking system 10 generates collision alerts and communicates the alerts to mobile communication devices of motorcycle 501, car 502, and bicycle 503.

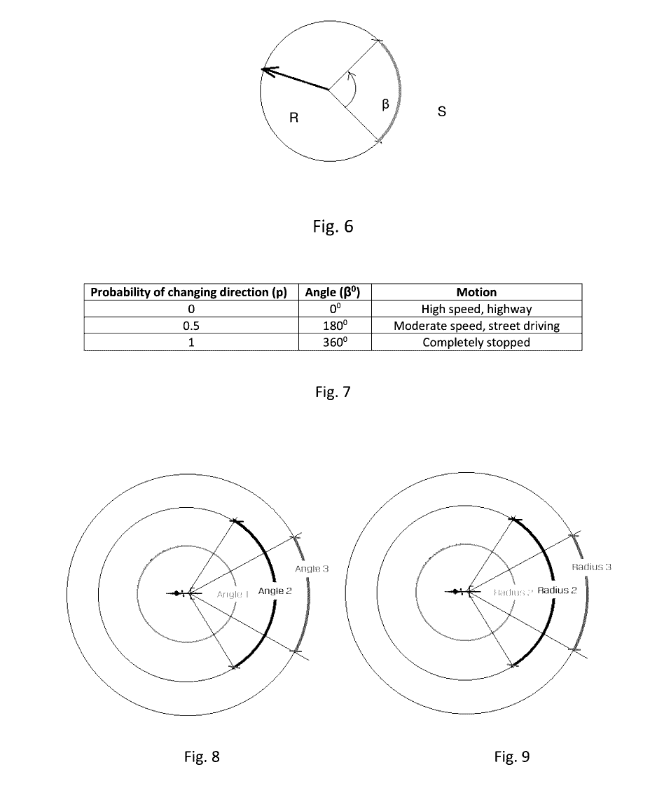

Referring to FIG. 6, in some embodiments, approaching vehicle warning app 28 uses an arc to determine the geospatial polygon shape. In this example, the arc shape is defined by the vehicle velocity (v), the probability of changing directions (p), the time-to-collision (TTC), and GPS inaccuracies.

In some embodiments, TTC is a fixed parameter defined by an administrator, and TTC represents the time car drivers get notified before intersecting with approaching cycles (e.g., 5 seconds).

The length of an Arc is defined by the following equation:

$$S = Arc Length = Radius \times Angle = R \times \frac{{β}^{0}}{{360}^{°}} 2 π$$

Modifying the preceding equation for the parameters of vehicle tracking system 10 yields the following equation:

$$S = S ( system 10 ) = Radius \times Angle = ( d + i ) \times \frac{{B}^{0}}{{360}^{°}} 2 π$$

where

d=f(velocity(v),time(TTC))=v×TTC

i=GPS innacuracy=10-15 m (constant)

β°=Sweeping Angle=f(probability of change directions (p))

Referring now to FIG. 7, an illustrative example of the probability of changing directions (p) is shown based on the speed of the vehicle.

Referring now to FIGS. 8 and 9, the angles and radius are shown for different arcs based on two velocities.

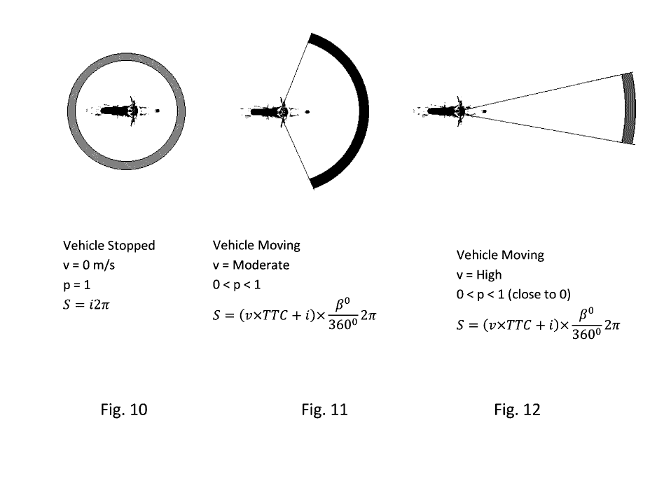

Referring now to FIG. 10, an arc is shown for a vehicle that is stopped with a velocity=v=0 m/s

d=f(velocity(v), time(TTC))=0×TTC=0 m

The probability of changing directions: p=1β=360°

In this case, the arc length becomes:

$$S = S ( system 10 ) = Radius \times Angle = ( 0 + i ) \times \frac{{360}^{°}}{{360}^{°}} 2 π = i 2 π = circunference$$

In other words, the arc is a full circle.

Referring now to FIGS. 11 and 12, an arc is shown for a vehicle that has a velocity greater than zero (Velocity=v>0 m/s), namely a moderate velocity and a high velocity, respectively:

d=f(velocity(v),time(TTC))=v×TTC

The probability of changing directions 0<p<1→0°<β°<360°

In this case, the arc length becomes:

$$S = S ( system 10 ) = Radius \times Angle = ( d + i ) \times \frac{{B}^{0}}{{360}^{°}} 2 π = ( v \times TTC + i ) \times \frac{{B}^{0}}{{360}^{°}} 2 π = arc$$

The arc is narrower for faster speeds.

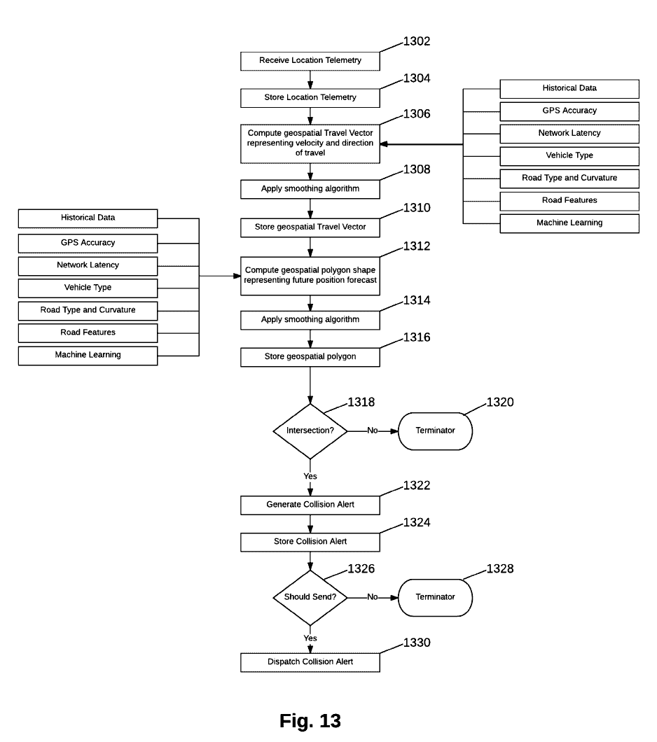

Referring now to FIG. 13, approaching vehicle warning app 28 receives location telemetry from mobile communication devices of vehicles at step 1302, and stores the location telemetry at step 1304 At step 1306, approaching vehicle warning app 28 computes a geospatial travel vector that represents velocity and direction of travel of vehicles. Approaching vehicle warning app 28 takes a series of location telemetry data and calculates vehicles velocity, acceleration rate and change of direction rates (rate of turn). This is accomplished by taking geo location pings and their corresponding timestamps data and then calculating a statistical mean of that data series to determine the rate of change. Based on the rate of change vehicle's velocity, acceleration and rate of turn can be calculated. Approaching vehicle warning app 28 plots the geospatial travel vector with the beginning of the vector anchored on the last location telemetry point and with the end location forecasted based on velocity, acceleration, rate of turn and Time To Collision Warning (TTCW) coefficient configured within approaching vehicle warning app 28. The algorithm also considers Historical Data, GPS accuracy, network latency, vehicle type, road type and its curvature and road features to further enhance the calculation. In some embodiments, machine learning is used to enhance the model over time ensuring that the algorithm gets better and it adapts itself to different areas and traffic conditions.

At step 1308, approaching vehicle warning app 28 applies a smoothing algorithm to the computed geospatial travel vector. Smoothing algorithms may be based, for example, on standard statistical equations designed to identify and adjust outliers within a given data series, which may be caused, for example, by missed location telemetry. At step 1310, approaching vehicle warning app 28 stores the computed geospatial travel vector.

At step 1312, approaching vehicle warning app 28 computes a geospatial polygon shape representing a future position forecast. In some embodiments, the geospatial polygon shape is anchored at the end of the geospatial travel vector and it represents a probability of a given vehicle to change direction to occupy any given portion of that space in the future based on velocity, acceleration, rate of turn and TTCW of that vehicle. In some embodiments, the geospatial polygon's shape and size is further enhanced by historical data, GPS accuracy, network latency, vehicle type, road type and its curvature and road features to further enhance the calculation. In some embodiments, machine learning is used to enhance the model over time ensuring that the algorithm gets better and it adapts itself to different areas and traffic conditions.

At step 1314, approaching vehicle warning app 28 applies a smoothing algorithm to the computed geospatial polygon shape. At step 1316, approaching vehicle warning app 28 stores the computed geospatial polygon shape.

At step 1318, approaching vehicle warning app 28 determines whether any computed geospatial polygon shapes intersect. If there is no intersection, at step 1320, approaching vehicle warning app 28 terminates the process until the next location telemetry is received or after a predetermined time.

Otherwise, if at step 1318 there is an intersection, at step 1322, approaching vehicle warning app 28 generates a collision alert. At step 1324, approaching vehicle warning app 28 stores the collision alert.

At step 1326, approaching vehicle warning app 28 determines whether to send a collision alert. If the determination is not to send a collision alert, at step 1328, approaching vehicle warning app 28 terminates the process until the next location telemetry is received or after a predetermined time. The vehicle flow management system described above may use the intersection information for traffic flow control.

Otherwise, if at step 1326, the determination is to a send a collision alert, at step 1330, approaching vehicle warning app 28 sends a collision alert to the vehicles that are determined to be on a potential collision path. The operators of the vehicles may take action based on the collision alert, which, in some embodiments, includes recommended actions. In some embodiments, the vehicle may automatically take actions without driver action for collision avoidance in response to the collision alert.

1. A method for providing traffic data, comprising:
receiving vehicle position data at a central data base from a plurality of vehicles, said signals received via separate connections from said vehicles;
tracking the speeds and positions of each of the plurality of vehicles;
determining, for each vehicle, a geometric polygon shape indicative of a path of said each vehicle from the tracked speeds and positions;
determining whether any two geometric polygon shapes intersect each other; and
notifying said two vehicles when any two geometric polygon shapes intersect each other.

2. The method of claim 1, wherein determining, for each vehicle, a geometric polygon shape indicative of a path of said each vehicle further comprises:
determining the geometric polygon shape based on probability of said each vehicle changing direction.

3. The method of claim 1, further comprising the preliminary step of:
receiving vehicle position information in each of the plurality of vehicles; and
communicating vehicle position data based on the position information for each of the plurality vehicles via cellular signals from said each of the plurality of vehicles.

4. The method of claim 1 wherein receiving vehicle position data at a central database further comprises:
receiving type data from motorcycles which distinguishes the motorcycles from other vehicles.
wherein determining, for each vehicle, a geometric polygon shape indicative of a path of said each vehicle from the tracked speeds and positions further comprises:
determining, for each motorcycle, a geometric polygon shape indicative of a path of said each motorcycle from characteristics of said motorcycle and tracked speeds and positions.

5. The method of claim 4, further comprising:
processing signals received from satellites in a computing system, such as a smartphone, on or in each of the plurality of vehicles to determine position information for said each vehicle; and
transmitting vehicle type data from at least each motorcycle in said plurality of vehicles with said vehicle position data.

6. The method of claim 5 further comprising:
determining vehicle type data for the at least one motorcycle in the plurality of vehicles from accelerator signals measured on said at least one motorcycle.

7. The method of claim 4, further comprising:
using the position data received at the central data base to create maps for navigation systems using routes and traffic patterns more suitable for two wheeled vehicles than for vehicles having four or more wheels.

8. The method of claim 1 wherein notifying said two vehicles when any two geometric polygon shapes intersect each other further comprises:
indicating the relative distance in space or time between said two vehicles.

9. A method for providing traffic data, comprising:
receiving vehicle position data at a central data base from a plurality of vehicles, said signals received via separate connections from said vehicles;
tracking the speeds and positions of each of the plurality of vehicles;
determining from the tracked speeds and positions when two vehicles are approaching each other and traveling in the same direction on the same roadway;
determining, for each vehicle of said two vehicles, a geometric polygon shape indicative of a path of said each vehicle from the tracked speeds and positions;
determining whether any two geometric polygon shapes intersect each other; and
notifying said two vehicles when any two geometric polygon shapes intersect each other.

10. The method of claim 9, wherein determining, for each vehicle of said two vehicles, a geometric polygon shape indicative of a path of said each vehicle further comprises:
determining the geometric polygon shape based on probability of said each vehicle changing direction.

11. The method of claim 9, further comprising the preliminary step of:
receiving vehicle position information in each of the plurality of vehicles; and
communicating the satellite based vehicle position data based on the position information for each of the plurality vehicles via cellular signals from said from each of the plurality of vehicles.

12. The method of claim 9 wherein receiving vehicle position data at a central data base further comprises:
receiving type data from bicycles which distinguishes the bicycles from other vehicles.

13. The method of claim 12, further comprising:
processing signals received from satellites in a computing system, such as a smartphone, on or in each of the plurality of vehicles to determine position information for said each vehicle; and
wherein determining, for each vehicle, a geometric polygon shape indicative of a path of said each vehicle from the tracked speeds and positions further comprises:
determining, for each motorcycle, a geometric polygon shape indicative of a path of said each bicycle from characteristics of said bicycle and tracked speeds and positions.

14. The method of claim 13 further comprising:
determining vehicle type data for the at least one bicycle in the plurality of vehicles from accelerator signals measured on said at least one bicycle.

15. The method of claim 12, further comprising:
using the position data received at the central database to provide data for creating maps for navigation systems using routes and traffic patterns more suitable for two wheeled vehicles than for vehicles having four or more wheels.

16. The method of claim 9 wherein notifying said two vehicles when any two geometric polygon shapes intersect each other further comprises:
indicating the relative distance in space or time between said two vehicles.

17. A method for providing traffic data, comprising:
receiving vehicle position data and vehicle type data at a central database from a plurality of vehicles, said signals received via separate connections from said vehicles;
tracking the speeds and positions of each of the plurality of vehicles;
predicting from the tracked speeds and positions of various vehicle types expected types of vehicle traffic flow based on historical analysis of related data from the central databased, and
notifying at least some of the vehicles that they have entered a notification zone.

18. The method of claim 17 wherein notifying said at least some of the vehicles further comprises:
notifying at least some of the vehicle types of recommended driving actions to take in said notification zone.

19. The method of claim 17 notifying said at least some of the vehicles further comprises:
notifying a vehicle management system in at least some of said vehicles of actions to be taken without driver action for collision avoidance.
